(19) United States
(12) Patent Application Publication
(10) Pub. No.: US 2026/0168920 A1
(43) Pub. Date: Jun. 18, 2026

(54) METHOD FOR CHECKING WAVELENGTH SHIFT ON A DETECTOR IN A SPECTROMETER

(71) Applicant: Analytik Jena GmbH+Co. KG, Jena (DE)

(72) Inventors: Thomas Weidauer, Jena (DE); Stefan Münch, Berlin (DE)

(21) Appl. No.: 19/424,413

(22) Filed: Dec. 18, 2025

(30) Foreign Application Priority Data
Dec. 18, 2024 (DE) 10 2024 138 666.5

(51) Int. Cl. G01N 21/31

(52) U.S. Cl. CPC G01N 21/31

(57) ABSTRACT

A method for checking wavelength shift on a spectrometer including a sample unit configured to produce light characteristics of a sample and a detector having multiple pixels for detecting the light as a spectrum includes: creating a first a first wavelength association, wherein wavelengths are associated with the pixels of the detect; acquiring a first spectrum of the sample, for which the first wavelength association is valid; acquiring a second spectrum of the sample; determining the wavelength shift between the first spectrum and the second spectrum based on a comparison of the first spectrum and the second spectrum; and creating a second wavelength association, wherein wavelengths are associated with pixels in the second spectrum based on the determined wavelength shift.

### CROSS-REFERENCE TO RELATED APPLICATION

The present application is related to and claims the priority benefit of German Patent Application No. 10 2024 138 666.5, filed on Dec. 18, 2024, the entire contents of which are incorporated herein by reference.

### TECHNICAL FIELD

The present disclosure relates to a method for checking wavelength shift on a detector in a spectrometer, wherein the spectrometer includes a sample unit and the detector, wherein the sample unit is embodied to produce a light characteristic for a sample, for example, to excite a sample for emission of a light or to irradiate a sample with light passing through the sample, wherein the detector has a plurality of pixels and is embodied to detect the produced light as a spectrum.

### BACKGROUND

In analysis, spectrometers serve for analysis of light radiated from an investigated sample, in given cases, an excited sample, or for analysis of light transmitted through the investigated sample. Referred to as light is electromagnetic radiation. The investigated light visits various optical components, such as lenses, filters, mirrors and/or gratings, finally, to reach a detector, which detects the light in the form of a spectrum.

Examples of spectrometers are absorption spectrometers and emission spectrometers. In the case of absorption spectrometers, light transmitted through a sample falls on the detector and determines, among other things, the extinction of the sample. Emission spectrometers examine the light emitted in the case of excitation of a sample and have, for example, an echelle grating. Echelle gratings are diffraction gratings having a high diffraction efficiency for high diffraction orders. In combination with a second dispersive element (grating or prism), echelle gratings enable the production of a two-dimensional diffraction order structure. In this way, precise analysis of the sample is enabled.

For wavelength association of the pixels of the detector, a reference measurement is performed. For example, a reference lamp having a known wavelength sends light to the detector. Based on the location of the light of the reference lamp on the detector, then the pixels can be associated with the wavelengths. Since the positions of the wavelengths on the detector can change with time due to thermal drift and/or additional reasons such as pressure fluctuations in the spectrometer, or oscillations in motors for moving optical components of the spectrometer, the reference measurement is regularly repeated and, for example, redetermined before each sample measurement. This requires, however, extra measurements between the sample measurements.

### SUMMARY

It is, consequently, an object of the present disclosure to provide a method enabling easy checking of wavelength shift.

The object is achieved according to the present disclosure by a method as defined in the present disclosure.

According to the present disclosure, the object is achieved by a method for checking wavelength shift on a detector in a spectrometer, wherein the spectrometer includes a sample unit and the detector, wherein the sample unit is embodied to produce a light characteristic for a sample, for example, to excite a sample for emission of a light or to irradiate a sample with light passing through the sample, wherein the detector has a plurality of pixels and is embodied to detect the produced light as a spectrum, wherein the method comprises steps as follows:
creating a first wavelength association, in that wavelengths are associated with the pixels of the detector,
taking a first spectrum of a sample, for which first spectrum the first wavelength association is valid,
taking a second spectrum of the sample,
ascertaining a wavelength shift between the first spectrum and the second spectrum based on a comparison of the first spectrum and the second spectrum,
creating a second wavelength association, wherein wavelengths are associated with the pixels in the second spectrum based on the ascertained wavelength shift.

According to the present disclosure, a first wavelength association is provided and applied for the first spectrum. By means of comparison between the first spectrum and the second spectrum, it is determined that a wavelength shift has been ascertained between the two spectra. In this way, a reference measurement between the first spectrum and the second spectrum is avoided and the sample can be examined faster spectrally. For example, the detector is embodied to show the intensity of the produced light per pixel. The so formed spectrum shows then for each pixel an intensity of the light. In the context of the present disclosure, intensity is defined as a light intensity. The wavelength shift can occur horizontally, vertically or transversely to the detector. Therefore, the wavelength shift can be determined as a 2D-vector. By means of the 2D-vector, the wavelengths can be so shifted relative to the pixels that they correspond to the second wavelength association. The translation values in the 2D-vector can be smaller than the pixel size. The second spectrum may be taken after the first spectrum. In given cases, no drift can occur between the first spectrum and the second spectrum, so that the wavelength shift equals zero and the second wavelength association corresponds to the first wavelength association.

The method of the present disclosure is applicable for absorption- and emission spectrometers. The method is advantageous for echelle spectrometers, such as ICP-OES spectrometers (inductively coupled plasma optical emission spectroscopy), which have no thermostating. Drift in ICP-OES spectrometers is frequently met with thermostating of the spectrometer, thus it is heated or cooled, in order to prevent wavelength shifting as much as possible. Echelle spectrometers without such thermostating require, consequently, many reference measurements. By means of the method of the present disclosure, these are reducible to a minimum. Likewise, the method of the present disclosure can be advantageously applied for atomic absorption spectrometers.

In at least one embodiment, the method comprises steps as follows:
taking a first spectrum of a sample, which first spectrum includes a plurality of spectral structures, for example, emission structures, wherein at least one of the spectral structures is selected in the first spectrum as test structure,
taking a second spectrum of the sample and finding the test structure in the second spectrum,
ascertaining a wavelength shift between the first spectrum and the second spectrum based on a comparison of the test structures of the first spectrum and the second spectrum,
creating a second wavelength association, wherein wavelengths are associated with the pixels in the second spectrum based on the ascertained wavelength shift.

The spectral structures correspond to wavelengths characteristic for the sample. The spectral structures are emission structures, when the sample unit is embodied to excite a sample for emission of a light. The exciting of the sample can occur, for example, by means of a plasma. The emission structures have a positive light intensity and are visible as bright regions in the spectrum.

Alternatively, the spectral structures can be absorption structures, when the sample unit is embodied to irradiate a sample with light passing through the sample. Since the absorption structures include a weakening of the light first radiated into the sample, the absorption structures are darker than the rest of the spectrum and include a lessened intensity. Therefore, in given cases, the first spectrum and the second spectrum can before the selecting, or finding, of the test structure, firstly be converted into an extinction spectrum. Alternatively, a first inverse spectrum and a second inverse spectrum can be formed from the first spectrum and the second spectrum, in that the reciprocal is formed for all intensities of the spectrum. In this way, the original absorption structures appear as positive structures in the inverse spectra or extinction spectra and enable an easier evaluation.

If more than two spectra of the sample are taken, then all spectra can be taken, before a test structure is selected. In this way, it can be assured that the selected test structure is well evaluatable in each spectrum.

The selected test structure can be a spectral structure characteristic for the sample and is therewith to be found in each spectrum of the sample. It is assumed that the form of the test structure remains the same in each spectrum, thus, does not change between the first spectrum and the second spectrum. With “form” is meant both the geometric arrangement of the test structure on the pixels as well as also the distribution of the intensities over the pixels of the test structure. The test structure essentially does not change structurally, but, instead, changes as a function of wavelength shift only in its position in the spectrum. Because of the discrete pixel raster, the detected intensity distribution can slightly differ between the spectra. Also the total intensity, thus, the sum of the intensities, does not change over the pixels of the test structure. This is not true, however, for transient spectral structures, which occur, for example, in measuring particular samples and in the case of which the intensity can fluctuate somewhat due to irregular concentration distributions in the sample. The test structure selected in the first spectrum is sought in the second spectrum. In such case, a first position of the test structure in the first spectrum and a second position of the test structure in the second spectrum can be ascertained. By comparison of the test structures in the first spectrum and in the second spectrum, a wavelength shift is found.

In at least one embodiment, selected as test structure is a spectral structure, which has a predetermined minimum area, a predetermined minimum signal-noise ratio and/or a predetermined minimum intensity. For a facilitated comparison of the test structures in the first spectrum and in the second spectrum, conditions can be placed on the selection of the test structure, such as that the test structure must have a predetermined minimum area, thus, for example, extends over a predetermined number of pixels. Furthermore, a condition can be that the test structure has a predetermined minimum signal-noise ratio, thus, the ratio of signal to noise has a minimum value. Another condition can be that the test structure has a predetermined minimum intensity, that thus the sum of the intensities of the light over all pixels, over which the test structure extends, is formed and this sum lies above the predetermined minimum intensity.

In at least one embodiment, the comparison of the test structures in the first spectrum and in the second spectrum occurs based on a determining of the intensity centers of the test structures. Referred to as intensity center is a center of the test structure, which is determined, however, not based on a mass distribution, but, instead, in similar manner based on the distribution of the intensities of the light over the pixels. For such purpose, typical methods for determining centers of mass be can used, wherein the mass is replaced by the intensity of the light and the position by the pixels. For example, the pixels, over which the test structure extends, are, in each case, weighted with an intensity associated with each pixel. In such case, the pixels can be decomposed into a plurality of subpixels, which are, in each case, weighted with their respective intensities. Based on the intensity distribution produced in such a way, then the intensity center can be determined. For example, by means of this embodiment, translation values for the wavelength shift are obtained, which can be less than pixel size.

In at least one embodiment, the wavelength shift corresponds to the difference, for example, a vector difference, of the intensity centers of the test structures in the first spectrum and in the second spectrum. Since the test structure in both spectra is structurally identical and only its position in the spectra changes as a function of wavelength shift, such can be ascertained based on the difference between the intensity centers of the test structures in the first spectrum and in the second spectrum.

In at least one embodiment, the comparison of the test structures in the first spectrum and in the second spectrum occurs based on a fitting of the test structures to a function of second order or higher. The function can be a Gauss- or Lorentz function. The test structure can be fitted to the function such as two-dimensionally imaged on the detector. Alternatively, the pixels of the test structure in an axis of the detector can be summed, thus, added, and fitted in this one-dimensional representation. The expected value of the Gauss function, or the maximum of the Lorentz function, corresponds then to the intensity center of the test structure. In such cases, it is assumed that the intensity distribution of the test structure is symmetrical. By comparing the expected values or the maxima of the test structures in the first spectrum and in the second spectrum, the wavelength shift can be ascertained.

In at least one embodiment, the comparison of the test structures in the first spectrum and in the second spectrum occurs based on an edge of the test structure. The edges of the test structure correspond to a transitional region from a background signal to an intensity of the test structure and include a strong increase of the intensity, whereby it can be well detected. By selection of an edge and the comparison of the position of the edge in the first spectrum and in the second spectrum, the wavelength shift can be ascertained.

In at least one embodiment, the test structure in the second spectrum is found based on a first position of the test structure in the first spectrum. For finding the selected test structure in the second spectrum, it is advantageous to ascertain a first position of the test structure in the first spectrum and to seek the test structure in the second spectrum based on the first position. The first position of the test structure is, due to the wavelength shift between the first spectrum and the second spectrum, different from a second position of the test structure in the second spectrum. It is expected that the test structure in the second spectrum is located in the neighborhood of the first position.

In at least one embodiment, finding the test structure in the second spectrum comprises steps as follows:
determining a first position of the test structure in the first spectrum,
finding a spectral structure in the second spectrum in a predetermined region surrounding the first position,
comparing a form of the test structure in the first spectrum with a form of the spectral structure found in the second spectrum,
when a deviation of the two forms lies within a tolerance range, determining that the found spectral structure corresponds to the test structure,
when the deviation of the two forms lies outside of the tolerance range, terminating the method.

The test structure in the second spectrum can be ascertained based on a first position of the test structure in the first spectrum. In such case, it is expected that a second position of the test structure in the second spectrum will lie within a predetermined region surrounding the first position of the test structure. If the second position of the test structure lies outside of the predetermined region, that would mean that a considerable wavelength shift had occurred, which then can no longer be ascertained by comparing the first spectrum and the second spectrum, but, instead, by a new first wavelength association, for example, by a new reference measurement. The reference measurement should ideally enable a higher accuracy of the wavelength association. If, thus, no spectral structure is found in the predetermined region surrounding the first position, then the method is terminated at this point.

If a spectral structure can be ascertained in the predetermined region surrounding the first position, then the form of the test structure in the first spectrum is compared with a form of the found spectral structure. Since it is assumed that the form of the test structure remains essentially the same, it can be established that the found spectral structure corresponds to the test structure, when a deviation of the form of the found spectral structure lies within a tolerance range of the form of the test structure in the first spectrum. If the difference between the two forms lies outside of a tolerance range, the ascertained spectral structure is not the test structure of the first spectrum and the method is terminated.

In at least one embodiment, a plurality of spectral structures in the first spectrum are selected as test structures and the test structures are found in the second spectrum, wherein the wavelength shift between the first spectrum and the second spectrum is ascertained based on a comparison of the test structures of the first spectrum and the second spectrum. Since a plurality of test structures is selected in the first spectrum and the wavelength shift ascertained based on the plurality of test structures, the wavelength shift is determined with a higher accuracy. For example, a wavelength shift can be ascertained for each test structure and then an average value of the wavelength shifts calculated, which average value is then used as wavelength shift between the first spectrum and the second spectrum. Outliers occurring in given cases can be left out. In certain embodiments, the test structures and the wavelength shifts associated with them can experience a weighting, e.g. based on a signal-to-noise ratio of the test structures, which then influences the average value formation.

In at least one embodiment, the first spectrum is divided into a plurality of subregions and a spectral structure in a plurality of subregions is selected as test structure. Because test structures are selected from different subregions of the first spectrum and the wavelength shift is ascertained based on a comparison of the test structures, a higher accuracy of the ascertained wavelength shift is achieved.

In at least one embodiment, the comparison of the first spectrum and the second spectrum occurs based on an autocorrelation of the two spectra. The concept of autocorrelation comes from stochastics and signal processing and typically describes the correlation of a function or a signal with itself at another point in time. In the present disclosure, autocorrelation functions are utilized, in order to compare the first spectrum with the second spectrum, wherein the first spectrum can be considered as an earlier point in time of the second spectrum. By means of the autocorrelation, it is checked, to what extent the first spectrum and the second spectrum are identical, or different. In this way, the wavelength shift between the first spectrum and the second spectrum can be ascertained.

In at least one embodiment, in the first spectrum and in the second spectrum, in each case, a subregion is selected, wherein the comparison of the first spectrum and the second spectrum occurs based on an autocorrelation of the two subregions of the first spectrum and the second spectrum. The subregions of the first spectrum and the second spectrum comprise the same region of the respective spectra. Since only a subregion of the spectra is compared, instead of the total spectra, the wavelength shift can be ascertained in shorter time.

In at least one embodiment, the method further comprises additional steps as follows:
taking a third spectrum,
ascertaining a wavelength shift between the first spectrum and the third spectrum based on a comparison of the first spectrum and the third spectrum, or ascertaining a wavelength shift between the second spectrum and the third spectrum based on a comparison of the second spectrum and the third spectrum,
creating a third wavelength association, wherein wavelengths are associated with the pixels in the third spectrum based on the wavelength shift ascertained between the second spectrum and the third spectrum or based on the wavelength shift ascertained between the first spectrum and the third spectrum.

Frequently, not only first and second spectra of the sample are taken, but, instead, yet others, such as a third, fourth or fifth spectrum. If another spectrum, for example, a third spectrum, is taken, then the wavelength shift can also be ascertained for the third spectrum and any other spectra. Such can happen, on the one hand, based on a comparison of the previously taken spectrum, for example, the second spectrum, with the current spectrum, for example, the third spectrum. Alternatively, it is also possible to ascertain the wavelength shift based on a comparison of an earlier spectrum, for example, the first spectrum, and the current spectrum, for example, the third spectrum. The third spectrum may be taken after the first spectrum and after the second spectrum.

In at least one embodiment, the method further comprises additional steps as follows:
taking a third spectrum,
ascertaining a wavelength shift between the second spectrum and the third spectrum based on an extrapolation of the wavelength shift between the first spectrum and the second spectrum,
creating a third wavelength association, wherein wavelengths are associated with the pixels in the third spectrum based on the wavelength shift ascertained between the second spectrum and the third spectrum.

In this embodiment, the wavelength shift between the first spectrum and the second spectrum is extrapolated, in order to ascertain the wavelength shift between the second spectrum and the third spectrum. In such case, the first and the second wavelength associations can be used. This enables a fast creation of the third wavelength association. The third spectrum is taken after the first spectrum and after the second spectrum.

In at least one embodiment, the method further comprises additional steps as follows:
creating a first wavelength association, in that wavelengths are associated with the pixels of the detector,
taking a first spectrum of a sample, for which the first wavelength association is valid,
taking a second spectrum of the sample,
taking a third spectrum, wherein the third spectrum is taken after the first spectrum and before the second spectrum,
ascertaining a wavelength shift between the first spectrum and the second spectrum based on a comparison of the first spectrum and the second spectrum,
creating a second wavelength association, wherein wavelengths are associated with the pixels in the second spectrum based on the ascertained wavelength shift between the first spectrum and the second spectrum,
ascertaining a wavelength shift between the first spectrum and the third spectrum based on an interpolation of the wavelength shift between the first spectrum and the second spectrum,
creating a third wavelength association, wherein wavelengths are associated with the pixels in the third spectrum based on the wavelength shift ascertained between the first spectrum and the third spectrum.

If the wavelength shift between two spectra, here the first and the second spectrum, is known, then such can advantageously be applied for interpolating a wavelength shift for a spectrum, here the third spectrum, taken between the two spectra. This enables a fast creating of the third wavelength association.

In at least one embodiment, a reference spectrum is taken, wherein the first wavelength association is created based on the reference spectrum. The reference spectrum can be taken without sample and with at least one reference light source having a defined wavelength. An associating of the wavelengths with the pixels can occur based on the at least one defined wavelength of the at least one reference light source and the reference spectrum. Alternatively, also other defined spectral structures can be utilized for the first wavelength association. For example, a filter can be inserted in a beam path of the produced light between sample unit and detector, which filter allows the passage of only defined wavelengths. Based on a reference spectrum with the filter, it can be detected, which wavelengths of the filter have passed and appear on the detector, such that a wavelength association is possible. The reference spectrum can likewise be a spectrum of the sample, in which, for example, additional defined spectral structures of a reference light source or a filter are added. It is also possible to create a first wavelength association based on spectral structures of the sample, for example, when the components of the sample are, at least partially, known, or by means of a pattern recognition, which creates a pattern from the spectrum and compares such with a catalog of patterns, in order to detect the components of the sample from the pattern and to create a wavelength association based on the components, with which defined wavelengths are associated.

### BRIEF DESCRIPTION OF THE DRAWINGS

The present disclosure will now be explained in greater detail based on the appended drawing, the figures of which show as follows:

FIG. 1 shows a schematic view of a spectrometer;

FIG. 2 shows by way of example, a first spectrum;

FIG. 3 shows a view of a wavelength shift of a test structure.

### DETAILED DESCRIPTION

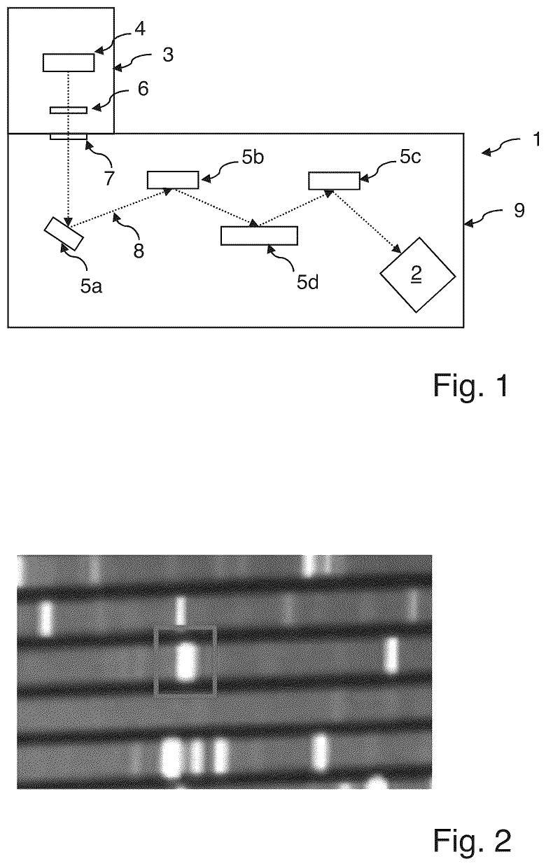

FIG. 1 shows a schematic view of the spectrometer 1 of the present disclosure. Spectrometer 1 includes a sample unit 3 and a detector 2. In certain embodiments, the spectrometer 1 has a plurality of optical components 5a-5d. Optical components 5a-5d are arranged and embodied in such a manner that they lead the beam path 8 of the produced light from the sample unit 3 to the detector 2. Detector 2 is embodied to detect the produced light in the form of a spectrum. Sample unit 3 can have a light source 4, which excites the sample for emission of light or irradiates the sample such that light passes through the sample. Light source 4 can be a plasma. Sample unit 3 can be embodied to bundle the produced light and to lead it into a main region 9 of the spectrometer. Sample unit 3 can have other optical components, such as, for example, an aperture diaphragm 6, an input opening, mirror and lenses, some of which may not be shown, in order to prevent clutter. Spectrometer 4 can have a slit 7. Slit 7 can be arranged between the sample unit 3 and the main region 9. Aperture diaphragm 6 can be arranged neighboring the slit 7. Optical components 5a,5b,5c can be mirrors. Optical component 5d is, for example, embodied as an echelle grating. Other optical components can include filters, prisms and/or lenses. Spectrometer 1 can be an ICP-OES device or an atomic absorption spectrometer.

FIG. 2 shows a first spectrum by way of example. Present in the first spectrum are a plurality of spectral structures. The first spectrum in this example is a section of an echellogram taken with an ICP-OES spectrometer. The section was selected, in order to make the spectral structures better recognizable. For example, the spectral structures are emission structures, which are visible as bright regions against a darker plasma background. The position of these emission structures on the detector can change with time due to thermal or other drifts. Therefore, for a precise evaluation of the spectrum, it is necessary to provide for a correct wavelength association in the spectrum.

Therefore, in the method of the present disclosure, firstly, a first wavelength association is created, for example, by means of a reference spectrum. Then, a first spectrum and a second spectrum can be taken. Based on a comparison of the two spectra, a wavelength shift is ascertained. In such case, the first wavelength association is valid for the first spectrum, which was taken, for example, shortly after the reference spectrum and the first wavelength association. Due to thermal or other drift, the first wavelength association is not unconditionally valid for the second spectrum. A wavelength shift may have occurred between the first spectrum and the second spectrum, and that possibility must be investigated.

One of the spectral structures in the first spectrum, namely here that highlighted in FIG. 2 by a frame around it, can be selected as test structure. This test structure is then found in the second spectrum. Based on a comparison of the test structures in the first spectrum and in the second spectrum, a wavelength shift between the first spectrum and the second spectrum can be ascertained.

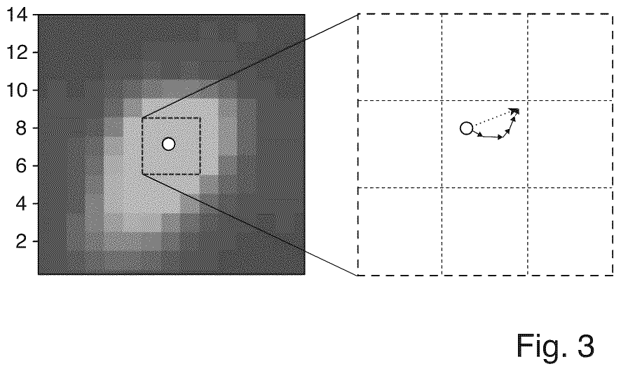

The left side of FIG. 3 shows a test structure in detail. It is clear that the test structure has higher intensities nearer to its center and lower intensities toward the outside of the test structure. Thus, the test structure has an intensity distribution. The circle, which is located approximately centrally in the image, marks the center of the intensity distribution of the test structure. Shown on the right side of FIG. 3 is how the intensity center of the test structure changes with time. Thus, the test structure in the first spectrum has an intensity center, which again is shown by a circle. Because of thermal or other drift, the intensity center of the test structure moves, firstly, to the right and then increasingly upwardly in the view, such as indicated by the arrows. Each arrow marks, in such case, the intensity center of the test structure in the subsequently taken spectrum. The dashed arrow marks the total shift of the wavelength over time. With the help of the evaluation of the intensity center of the test structure, a wavelength shift can be ascertained, which is smaller than the pixel size. Also this can be seen in the right part of FIG. 3, in which 3×3 pixels are shown. The change of the intensity center of the test structure moves, in such case, within one pixel.

1. A method for checking a wavelength shift on a detector in a spectrometer, wherein the spectrometer includes a sample unit and the detector, wherein the sample unit is configured to produce a light characteristic for a sample, wherein the detector has a plurality of pixels and is configured to detect the produced light as a spectrum, wherein the method comprises:
creating a first wavelength association, wherein wavelengths are associated with the plurality of pixels of the detector;
acquiring a first spectrum of the sample, for which the first wavelength association is valid;
acquiring a second spectrum of the sample;
determining the wavelength shift between the first spectrum and the second spectrum based on a comparison of the first spectrum and the second spectrum; and
creating a second wavelength association, wherein wavelengths are associated with a plurality of pixels in the second spectrum based on the determined wavelength shift.

2. The method of claim 1, wherein the first spectrum includes at least one spectral structure, and further comprising:
selecting a test structure from the at least one spectral structure;
locating a corresponding test structure in the second spectrum; and
comparing the test structures of the first and the second spectrum.

3. The method of claim 2,
wherein the test structure has at least one of: a predetermined minimum area, a minimum signal-to-noise ratio, and a predetermined minimum intensity.

4. The method of claim 2,
wherein comparing the test structures in the first and the second spectrum is based on intensity centers of the test structures.

5. The method of claim 4,
wherein the wavelength shift corresponds to a difference between the intensity centers of the test structures in the first and the second spectrum.

6. The method of claim 2,
wherein comparing the test structures in the first and the second spectrum is based on an edge of the test structure.

7. The method of claim 2,
wherein comparing the test structures in the first and the second spectrum is based on a fitting of the test structures to a function of second order or higher.

8. The method of claim 2,
wherein locating the test structure in the second spectrum is based on a first position of the test structure in the first spectrum.

9. The method of claim 2, wherein finding the test structure in the second spectrum comprises:
determining a first position of the test structure in the first spectrum;
finding a spectral structure in the second spectrum in a predetermined region surrounding the first position;
comparing a form of the test structure in the first spectrum with a form of the spectral structure found in the second spectrum;
when a deviation of the two forms lies within a tolerance range, determining that the found spectral structure corresponds to the test structure; and
when the deviation of the two forms lies outside of the tolerance range, determining that the found spectral feature does not correspond to the test structure.

10. The method of claim 2, wherein:
a plurality of spectral structures in the first spectrum are selected as test structures;
each of the test structures is located in the second spectrum; and
the wavelength shift between the first and the second spectrum is determined based on comparing the test structures of the first spectrum and the second spectrum.

11. The method of claim 10,
wherein the first spectrum is divided into a plurality of subregions and at least one spectral structure from each subregion is selected as test structure.

12. The method of claim 11,
wherein comparing the first spectrum and the second spectrum is based on an autocorrelation of the two spectra.

13. The method of claim 12,
wherein a subregion is selected from the first spectrum and from the second spectrum,
wherein comparing the first and the second spectra is based on an autocorrelation of the selected subregions of the first and the subregion of the second spectrum.

14. The method of claim 1, wherein the method further comprises:
acquiring a third spectrum;
determining a wavelength shift between the first spectrum and the third spectrum based on a comparison of the first spectrum and the third spectrum, or determining a wavelength shift between the second spectrum and the third spectrum based on a comparison of the second spectrum and the third spectrum; and
creating a third wavelength association, wherein wavelengths are associated with pixels in the third spectrum based on the wavelength shift determined between the second spectrum and the third spectrum or based on the wavelength shift determined between the first spectrum and the third spectrum.

15. The method of claim 1,
wherein a reference spectrum is taken, wherein the first wavelength association is created based on the reference spectrum.
